(19) United States
(12) Patent Application Publication
(10) Pub. No.: US 2008/0261194 A1
(43) Pub. Date: Oct. 23, 2008

(54) Method and apparatus for implementing an independent learning plan (ILP) based on academic standards

(76) Inventor: Theodore Craig Hilton, Columbus, NC (US)

Correspondence Address: JEFFER, MANGELS, BUTLER & MARMARO, LLP, 1900 AVENUE OF THE STARS, 7TH FLOOR, LOS ANGELES, CA, 90067, US

(21) Appl. No.: 11/788,393

(22) Filed: Apr. 18, 2007

(51) Int. Cl. G09B 7/00

(52) U.S. Cl. 434/362

(57) ABSTRACT

A process for generating and deploying a real-time automatic independent learning plan (ILP) for a person based on academic curriculum standards. More specifically, an automated process is disclosed that includes as a first step testing and remediation for students to determine the assessment of that student's competency and mastery of certain academic disciplines, followed by the automatic generation, based on such assessment, of an ILP, which is a unique and individualized set of learning content assembled to assist the particular student in learning one or more process standards.

### CLAIM OF PRIORITY UNDER 35 U.S.C. §119

The present Application for Patent claims priority to Provisional Application No. 60/792,936 entitled “Processing for generating and deploying a real-time automatic independent learning plan (ILP) based on academic curriculum standards,” filed Apr. 18, 2006, and hereby expressly incorporated by reference herein.

### BACKGROUND

1. Field

The present invention relates generally to educational learning systems, and more particularly, to a method and apparatus for implementing an independent learning plan (ILP) based on academic standards.

2. Background

Efforts have therefore been made to interactively assess and evaluate the knowledge levels and competencies of individuals with respect to certain academic disciplines the assessment and evaluation has been made in order to provide a basis for generating a learning plan specifically tailored to that person's needs or deficiencies. This learning plan, referred to as an independent learning plan (ILP), is a unique and individualized set of curricula and learning content assembled to assist a particular student in learning one or more process (or teaching) standards. A process standard is the lowest measured level of a curriculum standard, which itself is a codified benchmark applied to a specific academic discipline and grade that indicates an acknowledged measure of a fundamental learning principle.

There exist processes that measure the competency of an individual to create an ILP or “training regimen.” However, existing processes do not utilize a baseline framework of curriculum standards nor unique learning/feedback loops. For example. For children with special learning and educational requirements, an ILP is created by the teacher to focus on the unique needs and requirements of the student. This ILP typically contains a unique collection of all learning materials, such as workbook exercises, web-based learning animations, textbook passages and the like, that apply to the teaching, understanding, and learning of a process standard (all these teaching materials are collectively referred to as learning content). Because of the time constraints and teaching experience necessary to create, implement, deliver, and follow-through with an ILP, they are not generally applied to students without special needs.

One difficulty in assessing a student's academic skills involves the methodology used in making such a determination. Some testing programs simply test a student's basic skills to determine, for instance, whether the student understands multiplication of fractions. The testing procedure might include several fraction multiplication problems, which will indicate whether the student can solve the problem or not. However, such testing is only useful on a pass or fail basis. In other words, such basic testing will illustrate whether the student has mastered the skill or has not, but it will not determine the level of remediation required for the student to ultimately master the skill. Thus, it would be desirable to be able to determine a student's skill level in math, for instance, in such detail that it can identify the specific deficiencies that the student must overcome in order to master the skill. For example, if a student cannot multiply fractions, it should be determined whether the student has mastered multiplication of integers, which is a pre-requisite skill to multiplying fractions.

It would be desirable to address the shortcomings and difficulties noted above.

### SUMMARY OF THE PREFERRED EMBODIMENTS

This invention relates to a process for generating and deploying a real-time automatic independent learning plan (ILP) for a person based on academic curriculum standards. More specifically, this invention is an automated process that includes as a first step testing and remediation for students to determine the assessment of that student's competency and mastery of certain academic disciplines, followed by the automatic generation, based on such assessment, of an ILP, which is a unique and individualized set of learning content assembled to assist the particular student in learning one or more process standards.

Other features and advantages will become apparent to those skilled in the art from the following detailed description. It is to be understood, however, that the detailed description and specific examples, while indicating exemplary embodiments, are given by way of illustration and not limitation. Many changes and modifications within the scope of the following description may be made without departing from the spirit thereof, and the description should be understood to include all such variations.

### BRIEF DESCRIPTION OF THE DRAWINGS

The invention may be more readily understood by referring to the accompanying drawings in which:

FIG. 1 is a block diagram of an automatic independent learning plan system configured in accordance with one preferred embodiment of the present invention;

FIG. 2 is a generic flow diagram of an AutoILP configured in accordance with one preferred embodiment of the present invention;

FIG. 3 is a diagram of an AutoILP database table structure configured in accordance with one preferred embodiment of the present invention;

FIG. 4 is a flow diagram of an AutoILP implementation process configured in accordance with one preferred embodiment of the present invention; and,

FIG. 5 is a block diagram of a computer system configured in accordance with one preferred embodiment of the present invention.

Like numerals refer to like parts throughout the several views of the drawings.

### DETAILED DESCRIPTION OF THE PREFERRED EMBODIMENTS

In one preferred embodiment of the present invention, independent learning plan (ILP) may be thought of as a curriculum comprising a linear progression of skills, like building blocks, that are used to teach a student any academic skill. In math, for instance, a student must learn to count, to understand the concept of integers, and to perform basic addition and subtraction before moving on to more complex mathematical problems and calculations. In one preferred embodiment of the present invention, students are assigned to various categories, or entities, such as advanced, average or special needs. Any number of entities may be employed, but for the sake of simplicity, the three aforementioned entities will be discussed herein. In addition, a specific ILP may be used for each entity. For instance, if an advanced student must master 10,000 skills in order to graduate from high school, an ILP for an advanced student will endeavor to teach all 10,000 skills to that student prior to high school graduation. Similarly, if an average student must master 5,000 skills in order to graduate from high school, and a special needs student must master 3,000 skills in order to graduate from high school, then ILPs for those students would endeavor to teach only the requisite number of skills necessary for them to graduate.

Because the ILP may be thought of as a linear progression of skills, in one embodiment of the present invention the object of any testing program is to determine where along the linear progression any particular student falls. As a result of such testing, the student's academic skill level has been determined, and then a curriculum for that student may be developed accordingly. The academic skill level of a particular student may be viewed in terms of overall academic knowledge, or may be viewed through the prism of academic standards imposed by the school system or governmental entity, such as a state or local school system, or may be further viewed in terms of the student's academic entity (level) assigned by the state or local school, such as advanced, average, or special needs.

Regardless of the academic standards and entities imposed by the different educational authorities, the ILP is still a linear progression of skills, each of which must be learned in a particular order before moving to the next, more complex skill. Through testing, it would be desirable to determine not only which complex skills may not have been mastered by the student, but also which underlying basic skills that student may not have mastered, which would account for that student's failure to grasp more complex skill.

In one preferred embodiment of the present invention, the system provides every participating student, regardless of academic need or assessment, the process of determining a student's competency and mastery of a process, standard (or teaching standard) level, which is the lowest measurable level of a curriculum standard, a unique and completely personalized automatic ILP (AutoILP) as well as the process for implementing, delivering, feedback and follow-through with the AutoILP. The AutoILP is a self-instruction model that, among other attributes, allows a teacher/tutor to tailor assignment delivery in combinations of macro (i.e., entire class) or micro (i.e., single student) delivery, based solely on the requirements of the specific entity.

The present invention creates a unique ability to monitor the “differential improvement” of a given student over time within the confines of a particular entity. In one preferred embodiment of the present invention, for any given entity standard and student pair, a rising slope indicates progress. Similarly, a falling slope suggests retrogressing. That is, the differential at any given learning point in time for a given student represents that student's understanding of the material. The summation of the resultant slope over any given time segment (i.e., a semester) represents the differential change in the student's understanding of the standard. Each entry in the AutoILP represents one such dynamic summation. Each dynamic entry is subject to all real-time modifiers to the slope such as ongoing assessment and measured progress. A composite AutoILP represents all such summations for all applicable standards for a given student where the slope is negative. In another preferred embodiment of the present invention, the AutoILP can be constrained to accommodate any differentiation criteria—not simply a negative slope.

By taking the results of the student's performance of all activities (i.e., self directed, teacher/tutor-directed, reward-based), the system is able to build and maintain a real-time (dynamic) composite picture of a student's progress at any given arbitrary point in time. This differential snapshot allows the system to access a student's needs relative to any given entity standard at any given instant. Where the slope is negative, the applicable standard is entered into the student's personal AutoILP.

In one preferred embodiment of the present invention, the AutoILP is uniquely tailored to each student. The AutoILP becomes the student's “personal study guide”—which is basically a personalized textbook for each student—updated in real-time based on differential changes in student activities.

Today, all special needs children in public schools have an “Education Learning Plan” (“ELP”) created for them by law. The ELP sets out the areas of weakness of the student and how these areas will be taught over an academic year. The AutoILP of the present invention builds a similar plan. However, the AutoILP is automatically generated based on every activity of the student (i.e., periodic assessment, learning sessions, precedent learning), can be tailored by the teacher/tutor, and is self-editing.

In one preferred embodiment, the Automatic ILP is created based on a unique correlation of:

1) curriculum standards, which is a codified benchmark applied to a specific academic discipline that is a subject studied within an educational environment such as mathematics or language arts, and a grade that indicates an acknowledged measure of a fundamental learning principle;

2) learning content, which is a collection of all learning materials such as workbook exercises, web-based learning animations, textbook passages and the like, that apply to the teaching, understanding, and learning of a process standard;

3) test questions, which are questions with measurable answers that can be correlated to the accurate assessment of a particular process standard; and,

4) remediation, which is the explanation of how a correct answer is obtained to a specific test question, using a learning/feedback loop to constantly assess the progress of every student at every point along the Automatic ILP.

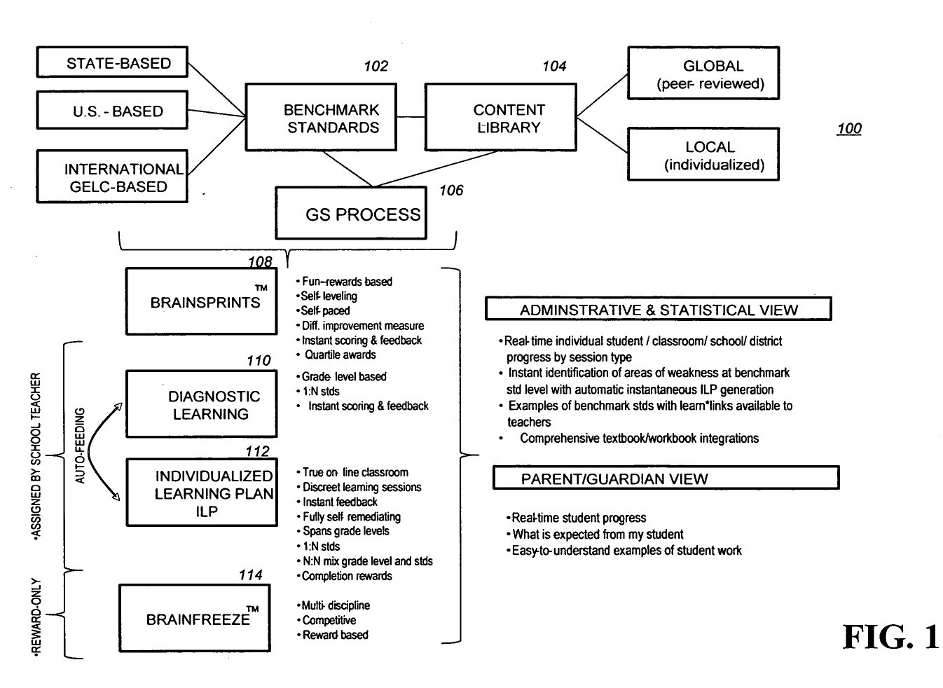

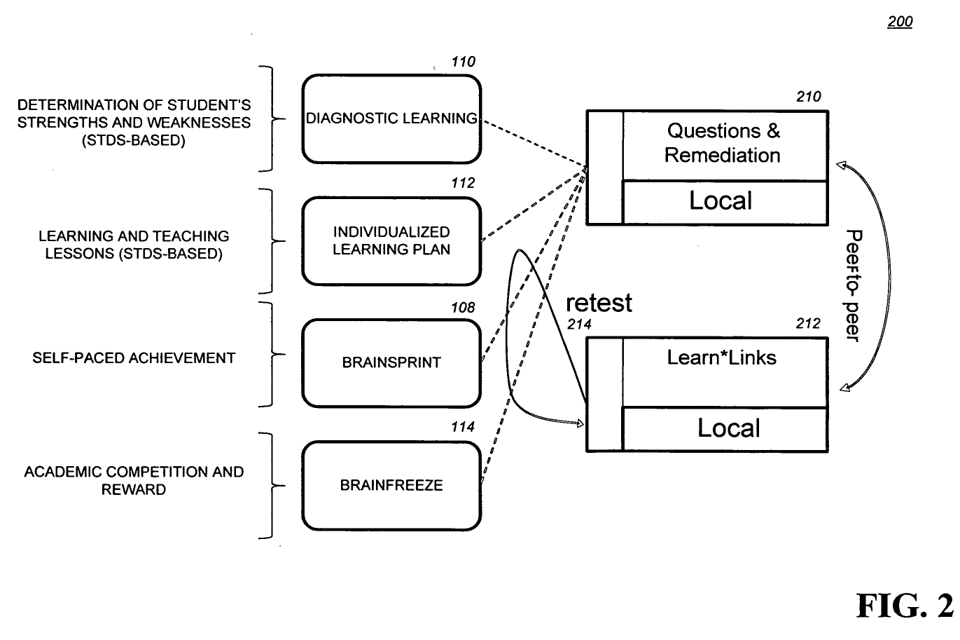

FIG. 1 illustrates an AutoILP system 100 configured in accordance with one preferred embodiment of the present invention, where a process (benchmark) standards block 102 contained within a curriculum standard framework, are matched in a one-to-many (hereinafter “1:N”) relationship with a content library 104 that includes test questions, remediation and learning content. Thus, each process standard has a sufficient number of affiliated test questions to adequately assess a student's understanding of the subject process standard. Each process standard test question also contains at least one remediation and a 1:N grouping of affiliated learning content. FIG. 2 illustrates a generic system flow diagram of the operation of the AutoILP system 100.

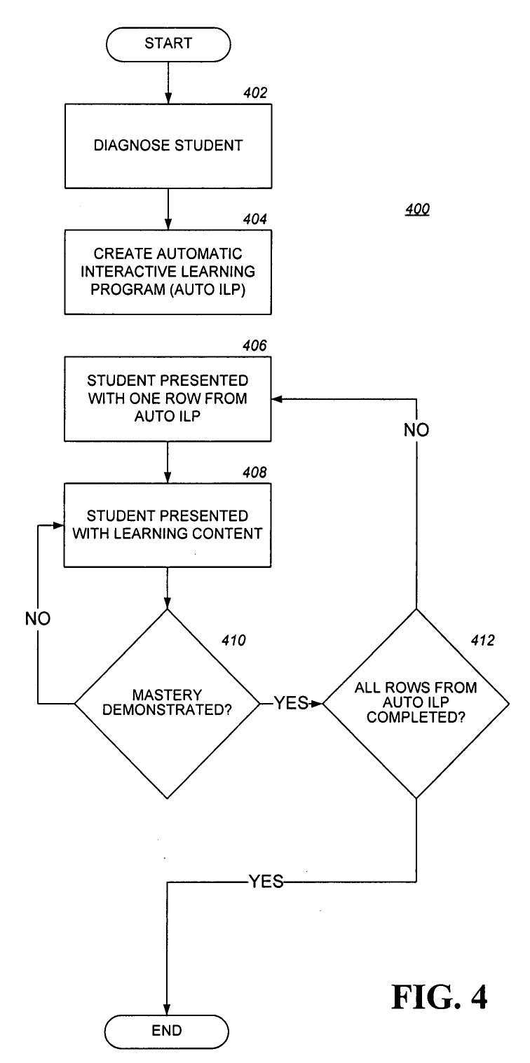

Referring to FIG. 4, in step 402 a diagnostic learning exam 110 that includes an examination composed of test questions adequate to assess the competency of a student to a particular process standard provided to diagnose the student. The process standard test questions contained in the diagnostic learning exam 110 are determined by an administering authority. In one preferred embodiment of the present invention, the test questions may be administered to a student in, for example, an online environment, and the primary delivery mechanism for this system and process will be networked computer systems in the online environment. It should be noted that other delivery mechanisms such as machine-scored exams are not excluded. This diagnostic learning exam block 110 is scored, and using the algorithm as described herein, an assessment is made of the student's understanding of the tested process standards.

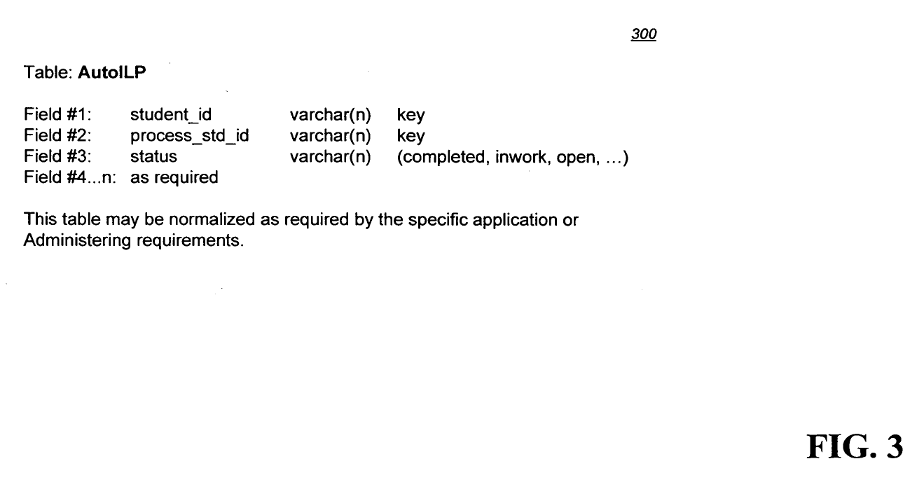

In one preferred embodiment of the present invention, in step 404, an AutoILP is created and stored in a computer data structure such as a database table. FIG. 3 outlines a sample data definition of an AutoILP database table 300. Those process standards that are assessed as being insufficiently understood by the student as determined by the diagnostic learning exam 110 and associated assessment algorithms are inserted (or “replaced”) into a new row of the AutoILP table 300. Each row of the AutoILP table 300 represents one process standard that is assessed as being insufficiently understood by a unique student. The AutoILP is the composite of all rows contained in the AutoILP table 300 for a unique student.

In one preferred embodiment of the present invention, as shown in step 406, the student is presented with one row from the Automatic ILP table for each individual learning session. A learning session is defined as a unique row of the AutoILP table 300 coupled to a learning/feedback loop. Learning content is iteratively presented to the student in step 408 in order to create an automated, self-correcting, self-instructional learning environment. An assessment feedback loop 214, as illustrated in FIG. 2, is created when the student is iteratively re-tested on the representative process standard represented by the table row.

In one preferred embodiment of the present invention, a feedback loop is established at the level of each row of the AutoILP table 300 by retesting the student using test questions (e.g., questions 210) related to the row. Upon successful demonstration of mastery the student moves on to the next row in the AutoILP table 300, as shown in step 410. In one preferred embodiment of the present invention, upon the determination of unsuccessful mastery of a row in step 410, the student is presented with additional learning content in step 408. In another preferred embodiment of the present invention, upon a determination of unsuccessful mastery of a row by either exhausting feedback test questions or learning content, the student is stilled moved on to the next row in the AutoILP table 300, but an alert is provided to the administering authority. As discussed herein, the mastery of a row is determined by detecting a positive slope in differential improvement.

The administering authority may follow the real-time progress of each student by examining the AutoILP table 300 for a unique student. Comparative analysis can be created by examining groups of rows within the AutoILP table 300, or by performing such inner and outer joins of the database tables as required.

This process provides a comprehensive real-time automatic feedback loop from student assessment through content learning through re-testing through matriculation, which is the assessment by an administering authority of a unique student's successful mastery of a process standard. For example, once the student has demonstrated mastery of all the rows in the AutoILP table 400, as determined by step 412, the process stops.

Other methodologies can be interfaced to the content library associated with each process standard contained in the curriculum standard framework, including interactive whiteboards and telephony connected to a remote teacher for purposes of online instruction, and the like.

The terms in FIGS. 1 and 2 of “BrainSprint” and “BrainFreeze” refer to ancillary remediation techniques that support and augment the AutoILP and are included in this document to demonstrate the simplicity with which external supportive systems and process may interface with this invention.

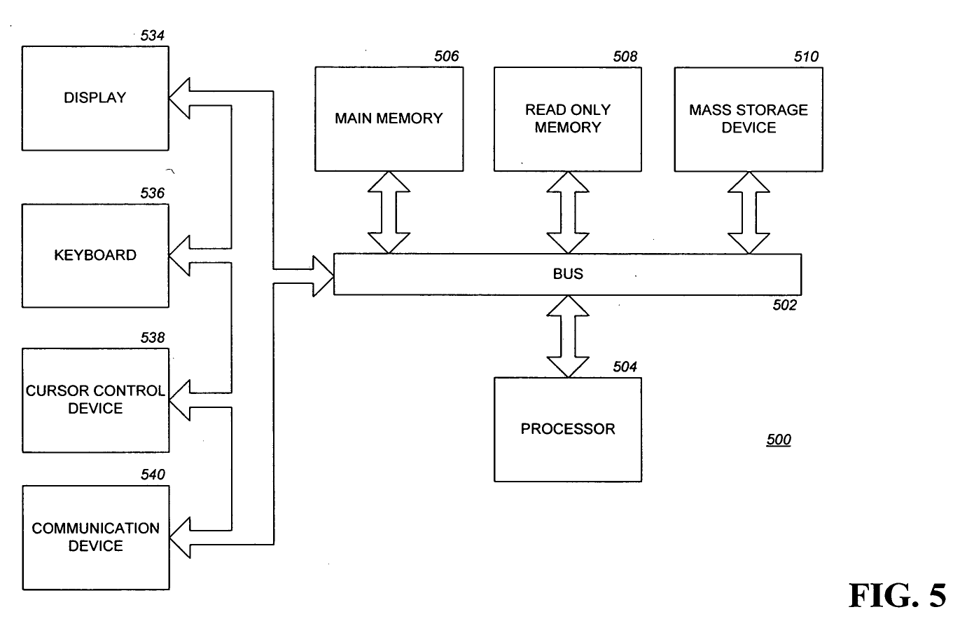

FIG. 5 illustrates an example of a computer system 500 in which the features of the present invention may be implemented. The computer system 500 includes a bus 502 for communicating information between the components in the computer system 500, and a processor 504 coupled with the bus 502 for executing software code, or instructions, and processing information. The computer system 500 further comprises a main memory 506, which may be implemented using random access memory (RAM) and/or other random memory storage device, coupled to the bus 502 for storing information and instructions to be executed by the processor 504, such as information and instructions necessary to implement the process described in FIG. 4. The main memory 506 also may be used for storing temporary variables or other intermediate information during execution of instructions by the processor 504. The computer system 500 also includes a read only memory (ROM) 508 and/or other static storage device coupled to the bus 502 for storing static information and instructions for the processor 504.

A communication device 540 is also coupled to the bus 502 for accessing other computer systems, as described below. The communication device 540 may include a modem, a network interface card, or other well-known interface devices, such as those used for interfacing with Ethernet, Token-ring, or other types of networks. In this manner, the computer system 500 may be coupled to a number of other computer systems.

A mass storage device 510, such as a magnetic disk drive and/or a optical disk drive, may be coupled to the computer system 500 for storing information and instructions, including the AutoILP table 300. The computer system 500 can also be coupled via the bus 502 to a display device 534, such as a cathode ray tube (CRT) or a liquid crystal display (LCD), for displaying information to a user (e.g., student) so that, for example, graphical or textual information may be presented to the user on the display device 534. Typically, an alphanumeric input device 536, including alphanumeric and other keys, is coupled to the bus 502 for communicating information and/or user commands to the processor 504. Another type of user input device shown in the figure is a cursor control device 538, such as a conventional mouse, touch mouse, trackball, track pad or other type of cursor direction key for communicating direction information and command selection to the processor 504 and for controlling movement of a cursor on the display 534. Various types of input devices, including, but not limited to, the input devices described herein unless otherwise noted, allow the user to provide command or input to the computer system 500. For example, in the various descriptions contained herein, reference may be made to a user “selecting,” “clicking,” or “inputting,” and any grammatical variations thereof, one or more items in a user interface. These should be understood to mean that the user is using one or more input devices to accomplish the input. Although not illustrated, the computer system 500 may optionally include such devices as a video camera, speakers, a sound card, or many other conventional computer peripheral options.

The steps of a method or algorithm described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. An exemplary storage medium is coupled to the processor, such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The embodiments described above are exemplary embodiments. Those skilled in the art may now make numerous uses of, and departures from, the above-described embodiments without departing from the inventive concepts disclosed herein. Various modifications to these embodiments may be readily apparent to those skilled in the art, and the generic principles defined herein may be applied to other embodiments without departing from the spirit or scope of the novel aspects described herein. Thus, the scope of the invention is not intended to be limited to the embodiments shown herein but is to be accorded the widest scope consistent with the principles and novel features disclosed herein. The word “exemplary” is used exclusively herein to mean “serving as an example, instance, or illustration.” Any embodiment described herein as “exemplary” is not necessarily to be construed as the most preferred or advantageous over other embodiments. Accordingly, the present invention is to be defined solely by the scope of the following claims.

1. A method for determining the instantaneous differential comprehension of a subject to a plurality of objectives, where a vector of comprehension is implicitly adjusted in real-time to reflect changes in the subject's comprehension based on activities.

2. The method of claim 1, further comprising providing an assessment of a competency of a student against at least one process standard.

3. A method for implementing an independent learning plan comprising:
assessing a competency of a student that is determined against at least one process standard;
creating a profile of the student based on the assessed competency;
implementing a learning feedback loop comprising:
(a) presenting learning content based on the assessed competency;
(b) testing the student to determine mastery of the learning content; and,
(c) repeating step (a) if the mastery of the learning content is not determined in step (b) to be at a first level.

4. The method of claim 3, wherein the competency is assessed against the process standard based on a plurality of test questions.

5. The method of claim 4, wherein the plurality of test questions are consistent with the process standard.

6. The method of claim 3, wherein creating the profile of the student comprises adding at least one process standard that is insufficiently reached.

7. The method of claim 3, wherein testing the student to determine mastery of learning content comprises detecting an improvement in the student.

8. The method of claim 7, wherein detecting the improvement in the student comprises detecting a differential improvement in the student.

9. The method of claim 8, wherein detecting the improvement in the student further comprises detecting a positive slope in the differential improvement of the student.

10. A computer-readable medium having computer-implemented instructions stored thereon that, when executed by a computer, causes the computer to implement a method for implementing an independent learning plan comprising:
assessing a competency of a student that is determined against at least one process standard;
creating a profile of the student based on the assessed competency;
implementing a learning feedback loop comprising:
(a) presenting learning content based on the assessed competency;
(b) testing the student to determine mastery of the learning content; and,
(c) repeating step (a) if the mastery of the learning content is not determined in step (b) to be at a first level.

11. The computer-readable medium of claim 10, wherein the competency is assessed against the process standard based on a plurality of test questions.

12. The computer-readable medium of claim 11, wherein the plurality of test questions are consistent with the process standard.

13. The computer-readable medium of claim 10, wherein creating the profile of the student comprises adding at least one process standard that is insufficiently reached.

14. The computer-readable medium of claim 10, wherein the competency is assessed against the process standard based on a plurality of test questions consistent with the process standard.

15. The computer-readable medium of claim 10, wherein testing the student to determine mastery of learning content comprises detecting an improvement in the student.

16. The computer-readable medium of claim 15, wherein detecting the improvement in the student comprises detecting a differential improvement in the student.

17. The computer-readable medium of claim 16, wherein detecting the improvement in the student further comprises detecting a positive slope in the differential improvement of the student.

18. An apparatus comprising:
a processor;
a memory coupled to the processor, the memory containing computer-readable program code that, when executed by the processor, causes the processor to implement a method for implementing an independent learning plan comprising:
assessing a competency of a student that is determined against at least one process standard;
creating a profile of the student based on the assessed competency;
implementing a learning feedback loop comprising:
(a) presenting learning content based on the assessed competency;
(b) testing the student to determine mastery of the learning content; and,
(c) repeating step (a) if the mastery of the learning content is not determined in step (b) to be at a first level.

19. The apparatus of claim 18, wherein the competency is assessed against the process standard based on a plurality of test questions.

20. The apparatus of claim 19, wherein the plurality of test questions are consistent with the process standard.

21. The apparatus of claim 18, wherein creating the profile of the student comprises adding at least one process standard that is insufficiently reached.

22. The apparatus of claim 18, wherein the competency is assessed against the process standard based on a plurality of test questions consistent with the process standard.

23. The apparatus of claim 18, wherein testing the student to determine mastery of learning content comprises detecting an improvement in the student.

24. The apparatus of claim 23, wherein detecting the improvement in the student comprises detecting a differential improvement in the student.

25. The apparatus of claim 24, wherein detecting the improvement in the student further comprises detecting a positive slope in the differential improvement of the student.
